(19) United States
(12) Patent Application Publication
(10) Pub. No.: US 2018/0104813 A1
(43) Pub. Date: Apr. 19, 2018

(54) ANIMATRONIC FEEDBACK BASED UPON SOCIAL MEDIA ACTIVITY

(71) Applicant: Soshee LLC, Redwood City, CA (US)

(72) Inventors: Jason Buzi, Redwood City, CA (US); Igor Dralyuk, Oakland, CA (US)

(21) Appl. No.: 15/296,914

(22) Filed: Oct. 18, 2016

(51) Int. Cl. B25J 9/00

(52) U.S. Cl. CPC B25J 9/0003

(57) ABSTRACT

Exemplary methods, apparatuses, and systems receive, from a social media service, a notification of an event for a social media account of a user. An event type of the event for the social media account of the user is determined. An animatronic action mapped to the determined event type within a stored data structure is identified. An instruction is transmitted via a wireless connection to an animatronic device to cause the animatronic device to perform the identified animatronic action in response to the received notification.

### FIELD

The various embodiments described herein relate to automating animatronic actions of a robotic toy. In particular, the embodiments relate to a robotic toy providing visual and/or audio feedback based upon social media notifications.

### BACKGROUND

Various types of social media and communication systems enable users to interact with various objects represented within the social media system. For example, these systems allow users to designate other users or entities as connections, contribute and interact with their connections, send messages, post media or commentary, share links to external content, and perform other tasks that facilitate social interaction. Additionally, these systems provide users with notifications of messages, interactions, activity, etc. For example, a social media application may include a graphical user interface element that indicates to the user that the user has received a message, another user has interacted with content created or shared by the user, or of another event corresponding to the user's social media account.

### BRIEF DESCRIPTION OF THE DRAWINGS

The present invention is illustrated by way of example and not limitation in the figures of the accompanying drawings, in which like references indicate similar elements, and in which:

FIG. 1 illustrates an exemplary network environment of devices to implement the automation of animatronic actions based upon social media interactions;

FIG. 2 illustrates exemplary user and animatronic devices to implement the automation of animatronic actions based upon social media interactions;

FIG. 3 illustrates an exemplary method of configuring animatronic actions automated based upon social media interactions;

FIG. 4 illustrates an exemplary user interface for granting third-party application access to a social media account to enable receiving notification of social media interactions and trigger animatronic actions; and

FIG. 5 illustrates an exemplary method of automating of animatronic actions based upon social media interactions.

### DETAILED DESCRIPTION

Embodiments described herein receive, from a social media service, a notification of an event for a social media account of a user. For example, a social media service may generate a notification of a message or content shared by another user. Upon receipt of the notification, embodiments determine an event type of the event. Embodiments may differentiate between, e.g., a direct message, a user account being tagged in content shared by another user, content shared by a specific user, etc. Using the event type, embodiments identify an animatronic action mapped to the determined event type. Animatronic actions may be mapped to event types by default or user-defined settings. Based upon the mapping, embodiments transmit, via a wireless connection to an animatronic device, an instruction to perform the identified animatronic action in response to the received notification.

In the following description, numerous specific details are set forth. However, it is understood that embodiments of the invention may be practiced without these specific details. While a social networking system is used to describe embodiments of social media actions that trigger animatronic actions, it will be understood that these concepts are generally applicable to other network services, social media, communication systems, etc. References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

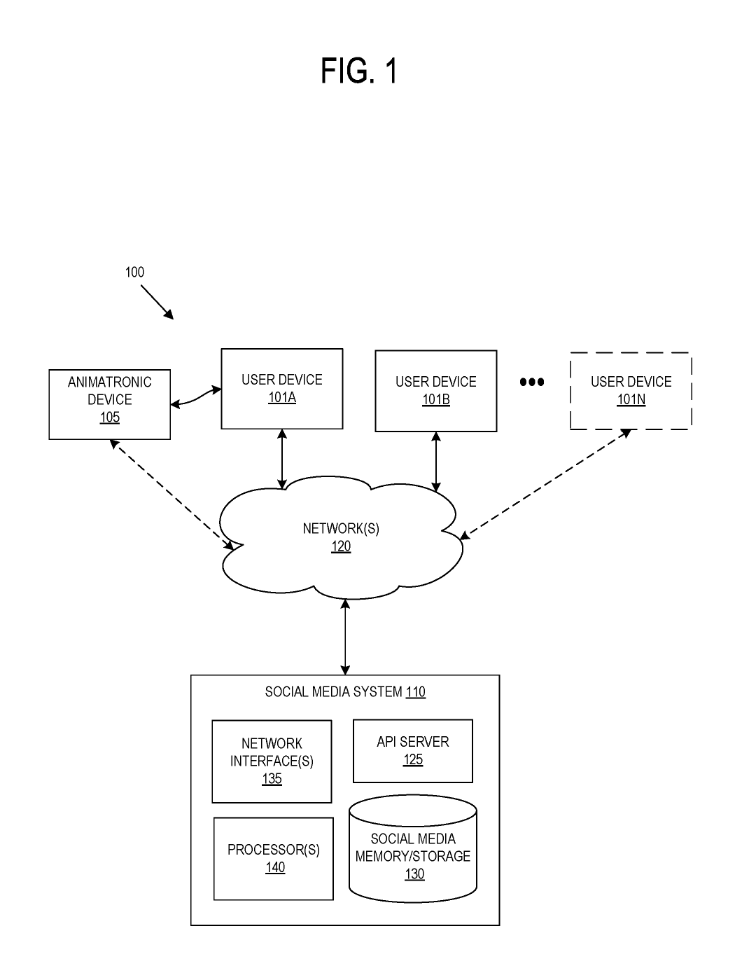

FIG. 1 illustrates exemplary network environment 100 of devices to implement the automation of animatronic actions based upon social media interactions. Network environment 100 includes user device(s) 101, animatronic device 105, and social media system 110.

In one embodiment, some of these devices communicate directly, e.g., user device 101A is illustrated as having a wireless connection to animatronic device 105. In one embodiment, some of these devices communicate indirectly via one or more networks. For example, user devices 101A-101N are configured to communicate with social media system 110 via network 120. Network 120 may include a collection of networks—such as the Internet, a corporate Intranet, a Virtual Private Network (VPN), a Local Area Network (LAN), a Wireless Local Area Network (WLAN), a cellular network, a Wide Area Network (WAN), a Metropolitan Area Network (MAN), or a combination of two or more such networks. Network 120 may be wired, wireless, or a combination of both.

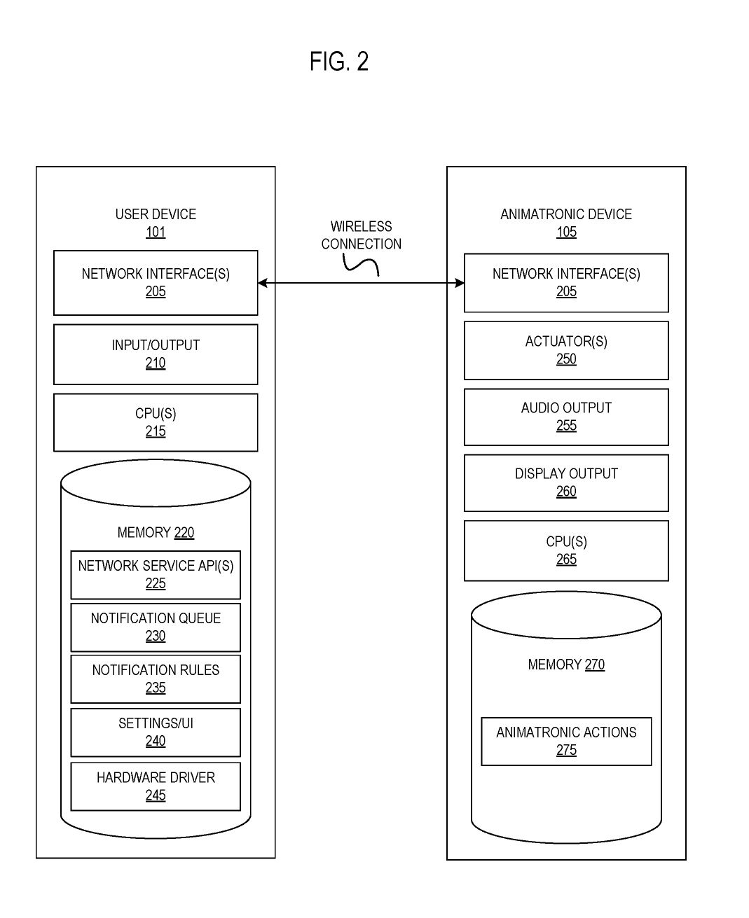

Exemplary components of user devices 101 and animatronic device 105 are illustrated in FIG. 2 and described further below.

Social media system 110 enables users, via devices 101A-101N, the ability to communicate and interact with other users and entities of the social media system 110. User devices 101A-101N interact with social media system 110 and can be any type of computing device capable of receiving user input as well as transmitting and/or receiving data via a network (e.g., network 120). Exemplary user devices 101A-101N include conventional computer systems, such as a desktop or laptop computer, or may include devices having computer functionalities such as Personal Digital Assistants (PDA), cellular or mobile telephones, smart-phones, in- or out-of-car navigation systems, gaming devices, or other electronic devices programmed to implement one or more embodiments set forth herein.

In one embodiment, a user device (e.g. 101A) executes a user application allowing a user of the user device 101A to interact with the social media system 110. For example, the user application may be a web browser application (e.g., Microsoft Windows Internet Explorer, Mozilla Firefox, Apple Safari, Google Chrome, Opera, etc.). In an embodiment, the user application is a special-purpose social media client application, which may utilize an Application Programming Interface (API) to directly interface with the social media system 110 through API server 125.

In one embodiment, social media system 110 includes one or more computing devices storing user profiles associated with users of devices 101A-101N and/or other objects, as well as connections between users and other users and/or objects. Social media system 110 stores user profiles, object data, and social media interactions in social media storage 130. Using social media system 110, users follow and/or add connections to other users or objects of social media system 110 to which they desire to be connected, and may also interact with these other users or objects. The users of the social media system 110 are individuals (e.g. humans), and the objects may include entities (such as businesses, organizations, universities, manufacturers, brands, celebrities, etc.), concepts, or other things presented for user interaction in social media system 110.

When a user takes an action within social media system 110, the action may be stored in social media storage 130. In some embodiments, these actions include interactions between users and/or users and objects within social media system 110 that result in user notifications. For example, in response to a message sent or other content shared by a user with one or more other users, social media system 110 generates a notification to alert user(s) of the message or shared content. Additionally, user interactions with content posted by a user may result in social media system 110 generating one or more notifications. Exemplary interactions with content include liking, sharing, and commenting on content shared by the user. Examples of other actions taken in social media system 110 include, but are not limited to, adding a connection to another other user, reading a message from the other user, viewing content (e.g., social media posts, images, videos) associated with or created by the other user, attending an event posted by another user, being tagged in photos with another user, etc.

In one embodiment, social media system 110 stores notification data in social media storage 130 in order to create a visual alert (e.g., on a representation of an application or feature within an application) or transmit notification data as email or other message. Notification data includes an indication of the interaction about which the user is to be alerted. For example, if the user has received a message from another user, the notification includes data representing that a message was received and, optionally, an identifier for the sender of the message. As another example, if the user follows another user that shares content via social media system 110, the notification includes a user identifier for the followed user and an indication of or identifier for the shared content.

In one embodiment, notification data is accessible via API server 125. API server 125 allows external systems (e.g., a third-party application running on user device 101) to access information from or transmit information to the social media system 110 by issuing API calls. API requests are received via network interfaces 135 and processed by API server 125. In response to API requests, API server 125 determines and transmits responses via network interface(s) 135 and network 120. For example, a third-party application running on user device 101A may transmit an API request for notification data associated with a particular user of social media system 110 in order to control animatronic device 105, as described further herein. In response to such a request, API server 125 transmits the corresponding notification data stored in social media storage 130.

Additional components, not shown, may also be part of social media system 110, and, in certain embodiments, fewer components than that shown in FIG. 1 may also be used in social media system 110. It will be apparent from this description that aspects of embodiments described herein are implemented, at least in part, in software. For example, the functionality of social media system 110 may be carried out in response to processor 140 executing sequences of instructions contained in a memory 130. While examples are described herein with reference to social media system 110, other embodiments may include other communication systems, such as chat and email systems. In such embodiments, social media system 110 may represent an email server, message server, or another communication system.

FIG. 2 illustrates exemplary user device 101 and animatronic device 105 to implement the automation of animatronic actions based upon social media interactions. User device 101 includes network and port interfaces 205, such as a port, connector for a dock, or a connector for a USB interface, FireWire, Thunderbolt, Ethernet, Fibre Channel, etc. to connect the user device 101 with another device, external component, or a network. Exemplary network and port interfaces 205 also include wireless transceivers, such as an IEEE 802.11 transceiver, an infrared transceiver, a Bluetooth transceiver, a wireless cellular telephony transceiver (e.g., 2G, 3G, 4G, etc.), or another wireless protocol to connect user device 101 with another device, external component, or a network and receive stored instructions, data, tokens, etc.

User device 101 also includes one or more input or output (I/O) devices and interfaces 210. I/O devices 210 also allow a user to provide input to, receive output from, and otherwise transfer data to and from the system. For example, I/O devices may include a display controller and/or display device. The display controller and display device provide a visual user interface for the user. I/O devices 210 may further include a mouse, keypad or a keyboard, a touch panel or a multi-touch input panel, camera, optical scanner, audio input/output (e.g., microphone and/or a speaker), other known I/O devices or a combination of such I/O devices.

User device 101 includes one or more microprocessors 215. User device 101 further includes memory 220, which is coupled to processor(s) 215. For example, memory 220 may include one or more of the data stores, including one or more of volatile and non-volatile memories, such as Random Access Memory (RAM), Read Only Memory (ROM), a solid state disk (SSD), Flash, Phase Change Memory (PCM), or other types of data storage.

Memory 220 may be used for storing data, metadata, and programs for execution by the processor(s) 215. For example, memory 220 includes one or more network service APIs 225 for accessing each of one or more social media systems. For example, one social media system may require an API request to be formatted differently from another social media system. To obtain notification data from each social media system, user device 101 uses the corresponding API 225 to format the request. In one embodiment, API 225 further enables user device 101 to facilitate the user granting permission for API 225, as a third-party application, to access notification data stored and controlled by the social media system. As described further herein, this may include obtaining an access token and/or key from the social media service, storing the token/key in memory 220, and using the token and/or key to request notification data.

Memory 220 further includes notification queue 230. Notification queue 230 stores notification data retrieved by API 225 until processed for transmitting instructions to animatronic device 105. In one embodiment, processor(s) 215 delete each notification entry in notification queue 230 upon transmission of the corresponding instruction to animatronic device 105 or upon confirmation of receipt of the corresponding instruction from animatronic device 105.

Memory 220 further includes notification rules 235. Notification rules 235 map notifications to actions to be performed by animatronic device 105. For example, notifications may be categorized by event type and each event type is mapped within a data structure to one or more movement, audio, and/or visual output instructions to be transmitted to animatronic device 105. Exemplary event types may differentiate social media interactions such as like, share, read, comment, etc. In one embodiment, event types differentiate between sentiments, such as like, love, laughter, amazement, anger, sadness, etc. In one embodiment, such sentiments are provided by the social media system as default interactions. In an alternate embodiment, sentiment is determined by identifying and mapping emoji or text content provided in the interaction to sentiments. Exemplary instructions identify an object to be moved, e.g., head, tail, body, ears, etc., vocalization to playback, and/or display devices such as light emitting diodes to activate. In one embodiment, the instructions include an amount of movement (e.g., in distance, degrees, time, etc.), volume and/or length of vocalization, or frequency and/or duration of visual output of light. In one embodiment, multiple instructions are chained together and triggered in sequence or parallel in response to a notification.

Memory 220 further includes settings and user interface (UI) module 240. UI module 240 generates a graphical user interface that enables a user to view and update settings for controlling animatronic device 105. For example, UI module 240 may display selectable event types for notifications and selectable animatronic actions to map to the event types. By manipulating the controls in the graphical user interface generated by UI module 240, the user can select notification triggers for various animatronic actions. In one embodiment, UI module 240 enables the user to differentiate between types of notifications and between other social media system users involved in the notifications when defining the settings.

Memory 220 further includes hardware driver 245. Hardware driver 245 provides access to network interfaces 205. For example, when processor(s) 215 process a notification in notification queue 230 and map the notification to an animatronic action using notification rules 235, processor(s) 215 transmit instructions for the animatronic action to animatronic device 105 via network interfaces 205 using hardware driver 245. Similarly, processor(s) 215 transmit API requests via network interfaces 205 using hardware driver 245.

One or more buses may be used to interconnect the various components illustrated in user device 101. User device 101 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, user device 101 may be a network computer, server, or an embedded processing device within another device or consumer electronic product. As used herein, the terms computer, device, system, processing system, processing device, and “apparatus comprising a processing device” may be used interchangeably with user device 101 and include the above-listed exemplary embodiments.

Animatronic device 105 also includes network and port interfaces 205, such as a port, connector for a dock, or a connector for a USB interface, FireWire, Thunderbolt, Ethernet, Fibre Channel, etc. to connect the animatronic device 105 with another device, external component, or a network. Exemplary network and port interfaces 205 also include wireless transceivers, such as an IEEE 802.11 transceiver, an infrared transceiver, a Bluetooth transceiver, a wireless cellular telephony transceiver (e.g., 2G, 3G, 4G, etc.), or another wireless protocol to connect animatronic device 105 with user device 101.

Animatronic device 105 also includes one or more output devices, such as actuators 250, a speaker for audio output 255, and light emitting diodes or other display output 260. In one embodiment, each actuator 250 controls movement of a portion of the body of animatronic device 105. For example, each actuator 250 may control movement of an animatronic head, ear, eye, mouth, neck, leg, tail, etc. In one embodiment, actuator 250 is a servomotor. In one embodiment, audio output 255 enables playback of an animal vocalization or other sound.

Animatronic device 105 includes one or more microprocessors 265. Animatronic device 105 further includes memory 270, which is coupled to processor(s) 265. For example, memory 270 may include one or more of the data stores, including one or more of volatile and non-volatile memories, such as Random Access Memory (RAM), Read Only Memory (ROM), a solid state disk (SSD), Flash, Phase Change Memory (PCM), or other types of data storage.

Memory 270 may be used for storing data, metadata, and programs for execution by the processor(s) 265. For example, memory 270 includes animatronic actions module 275. For example, animatronic actions module 275 causes processor(s) 265 to process instructions received from user device 101 and carry out those instructions by controlling actuator(s) 250, audio output 255, and/or display output 260. In one embodiment, animatronic actions module 275 interprets the received instructions into the corresponding hardware commands to control the corresponding output device(s). For example, animatronic actions module 275 may receive an instruction to move the head of animatronic device 105, determine which actuator(s) 250 control head movement, and control the amount of time and direction the actuator(s) 250 move to implement the received instruction. Alternatively, the instruction received from user device 101 includes which output devices are to be controlled and the details as to how to control them. In one embodiment, animatronic actions module 275 transmits a success message to user device 101 when the received instruction is implemented.

In one embodiment, animatronic actions module 275 tracks and/or monitors the state of one or more output devices. For example, animatronic actions module 275 may determine that an output device is already in the state requested by a received instruction or that a received instruction would cause an actuator 250 to rotate past a threshold position or otherwise exceed a threshold. In response, animatronic actions module 275 does not execute the instruction or executes the instruction up to the threshold. Further in response, animatronic actions module 275 may transmit an error message to user device 101. Alternatively, animatronic actions module 275 determines and executes a substitute output if the received instruction cannot be executed.

In one embodiment, animatronic actions module 275 returns animatronic device to a default state after performing an instruction received from user device 101. For example, each output device may have a default position or state and animatronic actions module 275 returns each output device to that default position or state. In one embodiment, returning animatronic device 105 to the default position includes performing the received instruction(s) in reverse.

In one embodiment, the default sate of an output device is dependent upon a time of day. For example, a daytime default position for animatronic device 105 may simulate a sitting or standing position of an animal while a nighttime default position may that of an animal lying down. Animatronic actions module 275 determines the time of day and, in response to a predetermined time, causes actuators 250 to move into the next time-dependent default position.

One or more buses may be used to interconnect the various components illustrated in animatronic device 105. While components in user device 101 and/or animatronic device 105 are illustrated separately, one or more components may be combined into a single component. Additional components, not shown, may also be part of user device 101 and/or animatronic device 105, and, in certain embodiments, fewer components than that shown in FIG. 2 may also be used in user device 101 and/or animatronic device 105.

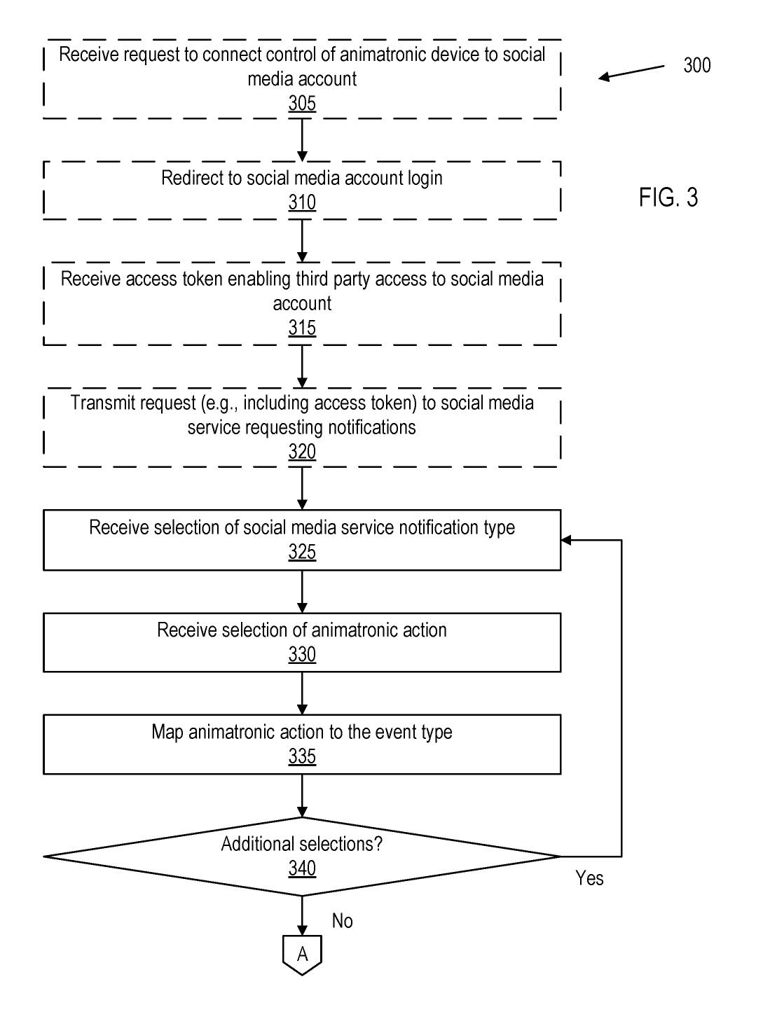

FIG. 3 illustrates exemplary method 300 of configuring animatronic actions automated based upon social media interactions. At block 305, the user device optionally (as indicated by broken lines) receives a request to connect control of animatronic device 105 to a user's social media account or otherwise grant third-party access to social media notifications to an application that controls animatronic actions.

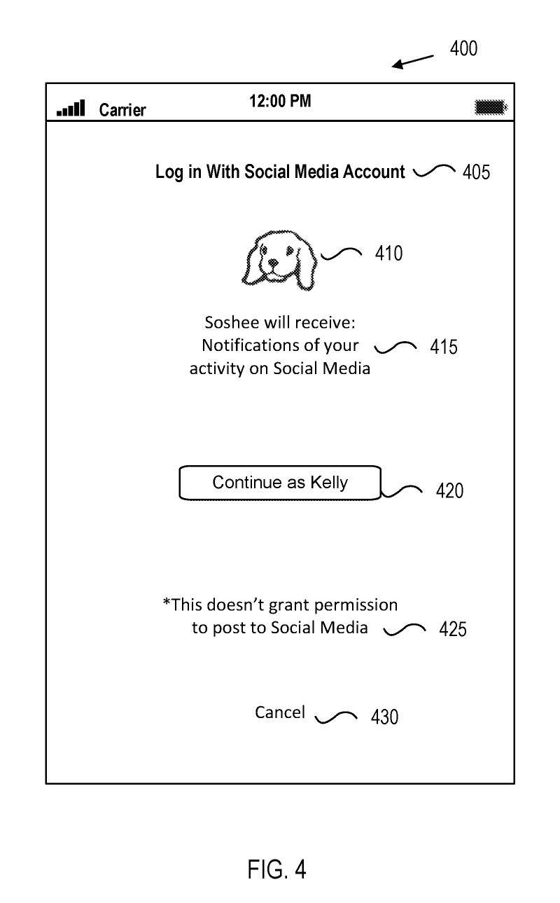

At block 310, in response to the request, the user device redirects the user interface to a login or other authentication page for the social media account. An exemplary redirected user interface is described with reference to FIG. 4 below. In one embodiment, the authorization is implemented according to OAuth or a similar protocol.

At block 315, the user device receives an access token or key in response to a user authentication of the request to connect animatronic device 105 to a user's social media account or otherwise grant third-party access to social media notifications. At block 320, the user device transmits a request for notification data. In one embodiment, the access token or key enables the user device to transmit API requests for social media notifications. For example, the user device includes the access token along with an API request in order for the social media system to authenticate the request.

At block 325, the user device receives selection of a social media service notification event type. At block 330, the user device receives selection of one or more animatronic actions to map to the selected event type. For example, the user device generates a user interface to enable selection of settings and receives user inputs to map an event type to action(s) as described above.

In one embodiment, the selection of settings includes the user selecting a threshold number of notifications of an event type to trigger the one or more animatronic actions. For example, the user device may receive configuration settings to trigger one or more animatronic actions in response to shared social media content receiving ten likes, shares, views, or another interaction. While each individual interaction may result in a notification, the user device does not trigger the animatronic action(s) until the threshold number (e.g., ten) of notifications of the event type have been received.

In one embodiment, the selection of settings includes the user selecting a period of time between animatronic actions. Alternatively, the time between animatronic actions is set to a default value. For example, the user device may aggregate notifications received within a time period and trigger one or more animatronic actions in response to the aggregated set of notifications rather than each individual notification. A happy sentiment may trigger, e.g., a wag of the animatronic device's tail while an angry or excited sentiment by trigger, e.g., an animatronic vocalization such as a bark.

At block 335, the user device maps the selected event type and animatronic action(s). In one embodiment, the user device updates a data structure to store the mapping.

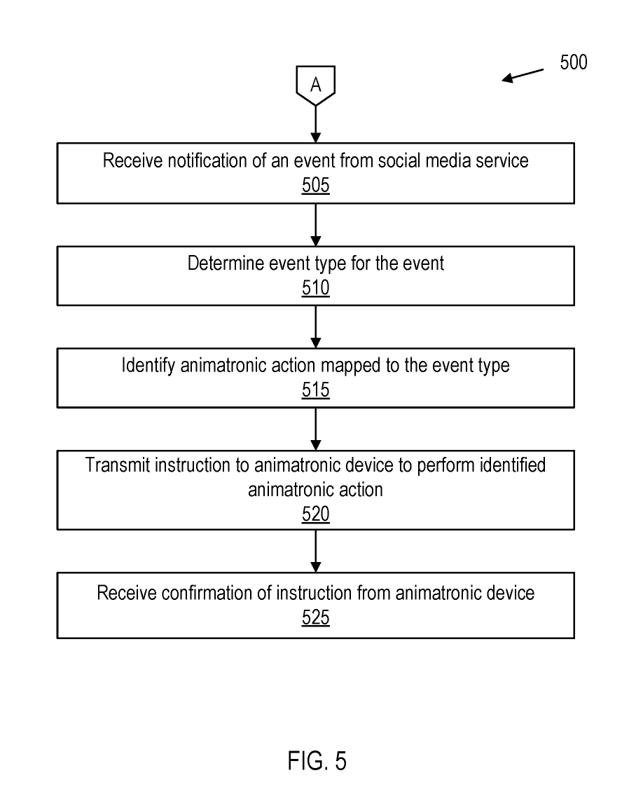

At block 340, the user device determines if there are additional selections to process. If the user inputs additional selections, method 300 returns to block 325. Otherwise, if the user finalizes the settings, method 300 continues via off page connector A to method 500 described with reference to FIG. 5.

FIG. 4 illustrates exemplary user interface 400 for granting third-party application access to a social media account to enable receiving notification of social media interactions and trigger animatronic actions. For example, as described above, an animatronic action setting user interface within a third-party application may include a user interface element (e.g., a software button) for connecting a social media account. User selection of the user interface element results in the user device redirecting the user from the animatronic action setting user interface of the third-party application to user interface 400 to authenticate the third-party access. In one embodiment, the redirection includes leaving the third-party animatronic action control application and launching another application to display user interface 400.

User interface 400 includes title 405 indicating to the user that the interface enables social media account authentication. In one embodiment, user interface 400 further includes logo or another image 410 identifying the third-party application requesting access to social media account notifications. User interface 400 further includes text 415 summarizing the access requested. For example, as illustrated, third-party application Soshee is requesting access to notifications associated with the user's social media account.

In one embodiment, the redirection to user interface 400 includes the user device identifying that the user is currently logged into the social media account. For example, the user device may store a cookie or otherwise keep a user logged into the social media account. In such an embodiment, user interface 400 includes user interface element 420 (e.g., a software button) to continue the authorization using the social media account. Alternatively, user interface 400 includes fields for the user, Kelly, to enter a username and password.

User interface 400 further incudes additional authentication information 425. For example, additional authentication information 425 may inform a user about the limits of the authentication. As illustrated, the authentication would allow third-party application Soshee to receive notifications but will not allow Soshee to post content to Kelly's social media account.

User interface 400 further includes another user interface element 430 (e.g., a software button) to enable the user to cancel connecting or otherwise granting authorization to the third-party application.

FIG. 5 illustrates exemplary method 500 of automating of animatronic actions based upon social media interactions. At block 505, the user device receives notification of an event from the social media service. In one embodiment, as described above, the notification data may be received in response to an API request transmitted by the user device and store the received notification data in a notification queue.

At block 510, the user device determines an event type of received notification data. For example, the user device processes the notification data at the head of the notification queue and identifies an event type within the notification data. In one embodiment, the event type is determined by comparing a field within the notification data with a list of expected notification event types. As described above, determining an event type may include differentiating different types of social media interactions as well as user device applying sentiment analysis to the interaction(s).

At block 515, the user device identifies an animatronic action mapped to the determined event type. For example, as described herein, the user device stores a data structure mapping default and/or user-defined mappings between event types and animatronic actions. In response to determining the event type (or reaching a threshold number of notifications of the event type), the user device uses the data structure to look up the corresponding animatronic action(s).

At block 520, the user device transmits an instruction to the animatronic device to perform the identified animatronic action(s). For example, as described herein, the user device uses a hardware driver to transmit a wireless signal including the instruction to the animatronic device. In one embodiment, the instruction includes an identification of a portion of the animatronic device that is subject to the action and the action to be taken. The action or actions simulate the behavior of the animal represented by the animatronic device. For example, if the animatronic device is a robotic dog, the instruction may identify the ears, eyes, head, legs, tail, or another portion of the robotic dog that will be subject to the action. The instruction may further indicate the action for the portion of the robotic dog, e.g., activate an actuator to lift ears, blink eyes, move the head, uses the legs to sit/stand/walk, open the mouth along with playback of barking audio, wag the tail, or another set of one or more actions to simulate a behavior of a dog.

In one embodiment, the user device aggregates notifications over a period of time and transmits instruction(s) to the animatronic device to perform the identified animatronic action(s) at the expiration of the period of time. If multiple of the aggregated notifications would result in triggering the same animatronic action, in one embodiment, the user device reduces the amount of times the animatronic action is to be performed at the end of the period of time. For example, if five notifications are aggregated during the time period and each would result in an instruction to cause the animatronic device to wag its tail, the user device may instruct the animatronic device to wag its tail once or twice rather than five times.

At block 525, the user device receives confirmation of the instruction from the animatronic device. For example, the animatronic device may send an acknowledgement upon receipt of the instruction and/or confirmation of execution of the action(s) in the instruction. In one embodiment, the user device deletes the notification from the notification queue in response to receiving the confirmation.

In one embodiment, method 500 returns to block 505 to process additional notifications. Additional notifications may be received, e.g., in response to additional API requests, as described with reference to block 320 of FIG. 3. For example, the user device may transmit API requests at a predetermined time interval in parallel with method 500. In one embodiment, user input to change settings within the third-party application may also cause method 500 to return to or operate in parallel to blocks 325 through 340 of FIG. 3.

It will be apparent from this description that aspects of the inventions may be embodied, at least in part, in software. That is, computer-implemented methods 300 and 500 may be carried out in a computer system, such as user device 101, in response to its processor executing sequences of instructions contained in a memory. In various embodiments, hardwired circuitry may be used in combination with the software instructions to implement the present embodiments. Thus, the techniques are not limited to any specific combination of hardware circuitry and software.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. A computer-implemented method comprising:
receiving, from a social media service, a notification of an event for a social media account of a user;
determining an event type of the event for the social media account of the user;
identifying, in a stored data structure, an animatronic action mapped to the determined event type; and
transmitting, via a wireless connection to an animatronic device, an instruction to perform the identified animatronic action in response to the received notification.

2. The computer-implemented method of claim 1, further comprising:
receiving a selection of the event type;
receiving a selection of the animatronic action; and
storing, in response to the received selections, the mapping of the selected event type to the selected animatronic action in the data structure.

3. The computer-implemented method of claim 1, further comprising:
transmitting, to the social media service, a request for the notification, wherein the notification is received in response to the request.

4. The computer-implemented method of claim 1, wherein the animatronic action includes movement of a head of the animatronic device.

5. The computer-implemented method of claim 1, wherein the animatronic action includes movement of a tail of the animatronic device.

6. The computer-implemented method of claim 1, wherein the animatronic action includes movement of ears of the animatronic device.

7. The computer-implemented method of claim 1, wherein the animatronic action includes audio playback of an animal vocalization.

8. The computer-implemented method of claim 1, wherein the animatronic device is an animatronic dog and the animatronic action simulates a behavior of a dog.

9. A non-transitory computer-readable medium storing instructions which, when executed by one or more processors in a processing device, cause the processing device to perform a method comprising:
receiving, from a social media service, a notification of an event for a social media account of a user;
determining an event type of the event for the social media account of the user;
identifying, in a stored data structure, an animatronic action mapped to the determined event type; and
transmitting, via a wireless connection to an animatronic device, an instruction to perform the identified animatronic action in response to the received notification.

10. The non-transitory computer-readable medium of claim 9, the method further comprising:
receiving a selection of the event type;
receiving a selection of the animatronic action; and
storing, in response to the received selections, the mapping of the selected event type to the selected animatronic action in the data structure.

11. The non-transitory computer-readable medium of claim 9, the method further comprising:
transmitting, to the social media service, a request for the notification, wherein the notification is received in response to the request.

12. The non-transitory computer-readable medium of claim 9, wherein the animatronic action includes movement of a head of the animatronic device.

13. The non-transitory computer-readable medium of claim 9, wherein the animatronic action includes movement of a tail of the animatronic device.

14. The non-transitory computer-readable medium of claim 9, wherein the animatronic action includes movement of ears of the animatronic device.

15. The non-transitory computer-readable medium of claim 9, wherein the animatronic action includes audio playback of an animal vocalization.

16. The non-transitory computer-readable medium of claim 9, wherein the animatronic device is an animatronic dog and the animatronic action simulates a behavior of a dog.

17. An apparatus comprising:
a processing device; and
a memory coupled to the processing device, the memory storing instructions which, when executed by the processing device, cause the apparatus to:
receive, from a social media service, a notification of an event for a social media account of a user;
determine an event type of the event for the social media account of the user;
identify, in a stored data structure, an animatronic action mapped to the determined event type; and
transmit, via a wireless connection to an animatronic device, an instruction to perform the identified animatronic action in response to the received notification.

18. The apparatus of claim 17, wherein the execution of the instructions further causes the apparatus to:
receive a selection of the event type;
receive a selection of the animatronic action; and
store, in response to the received selections, the mapping of the selected event type to the selected animatronic action in the data structure.

19. The apparatus of claim 17, wherein the animatronic action includes one or more of: movement of a head of the animatronic device, movement of a tail of the animatronic device, movement of ears of the animatronic device, and/or audio playback of an animal vocalization.

20. The apparatus of claim 17, wherein the animatronic device is an animatronic dog and the animatronic action simulates a behavior of a dog.
